(19) United States
(12) Patent Application Publication
(10) Pub. No.: US 2018/0211798 A1
(43) Pub. Date: Jul. 26, 2018

(54) PROTECTING COVER AND KEYBOARD

(71) Applicant: Primax Electronics Ltd., Taipei (TW)

(72) Inventor: MING-HAN WU, Taipei (TW)

(21) Appl. No.: 15/596,159

(22) Filed: May 16, 2017

(30) Foreign Application Priority Data
Jan. 20, 2017 (TW) 106102164

(51) Int. Cl. H01H 13/06; H01H 13/705; H01H 3/12; H01H 13/85

(52) U.S. Cl. CPC H01H 13/06; H01H 13/85; H01H 3/125; H01H 13/705

(57) ABSTRACT

The present invention relates to a protecting cover which covers a plurality of key caps of a keyboard. The protecting cover includes a connection pad and a plurality of cover bodies, where the connection pad is provided on a bottom plate of the keyboard. The cover body is provided on the connection pad and is covered at the corresponding key cap. The cover body includes an upper cover portion and a side wall portion. The upper cover portion covers an upper surface of the key cap, and the side wall portion surrounds the upper cover portion and covers a side edge of the key cap. Thickness of the side wall portion is smaller than thickness of the key cap, so that the side wall portion may be merely slightly deformed, so as to reduce a degree for the side wall portion to be squeezed.

### FIELD OF THE INVENTION

The present invention relates to a keyboard, and particularly to a keyboard using a scissors-type connecting assembly.

### BACKGROUND OF THE INVENTION

Common external input devices of a computer include a mouse, a keyboard, and a trackball. The keyboard may directly enter characters and symbols to the computer, and therefore is paid much attention to by users and manufacturers of the input devices. A keyboard including a scissors-type connecting assembly is much common.

Architecture of the keyboard including the scissors-type connecting assembly is described in the following, and description is made by using a key structure in the keyboard. Please refer to FIG. 1, and FIG. 1 is a sectional side view of a key structure of a conventional keyboard. A conventional keyboard 1 includes a key cap 11, a scissors-type connecting assembly 12, an elastic rubber body 13, a membrane switch circuit 14, and a bottom plate 15, where the bottom plate 15 is used to bear the key cap 11, the scissors-type connecting assembly 12, the elastic rubber body 13, and the membrane switch circuit 14. The scissors-type connecting assembly 12 is used to connect the bottom plate 15 and the key cap 11.

The scissors-type connecting assembly 12 is located between the bottom plate 15 and the key cap 11 and connects the bottom plate 15 and the key cap 11, separately. The scissors-type connecting assembly 12 includes a first frame 121 and a second frame 122. A first end of the first frame 121 is connected to the key cap 11, and a second end thereof is connected to the bottom plate 15. The elastic rubber body 13 is surrounded by the scissors-type connecting assembly 12, and the membrane switch circuit 14 includes a plurality of key contacts (not shown in the figure). The key contacts output corresponding key signals while being triggered. The elastic rubber body 13 is provided on the membrane switch circuit 14, and one elastic rubber body 13 corresponds to one key contact. When the elastic rubber body 13 is pressed, the elastic rubber body 13 is deformed and presses the corresponding key contact in the membrane switch circuit 14, so as to generate a key signal.

Subsequently, operating status that the conventional key structure 1 is pressed by a user is described. In FIG. 1, when the user presses the key cap 11, the key cap 11 is forced to push against the scissors-type connecting assembly 12 and make the same move. Therefore, the key cap 11 may move downwards with respect to the bottom plate 15 and press the corresponding elastic rubber body 13. At this time, the elastic rubber body 13 is deformed and presses the membrane switch circuit 14 to trigger the key contact of the membrane switch circuit 14, so as to enable the membrane switch circuit 14 to output the corresponding key signal. However, when the user stops pressing the key cap 11, the key cap 11 is not forced and stops pressing the elastic rubber body 13. As a result, the elastic rubber body 13 restores to an original state because of the elasticity, and an upward elastic restoring force is provided at the same time. Therefore, the key cap 11 is pushed back to a previous position at which the key cap 11 is not yet pressed. The foregoing are the structure and operating status of the conventional key structure.

During a process of the user operating the conventional keyboard, the conventional keyboard is placed at a work surface which is often a table top. Moreover, the user often places drink or tea at a position adjacent to the conventional keyboard on the table top, being convenient to drink while operating the conventional keyboard. However, the drink or tea is easy to be spilled because of carelessness of the user. As a result, an external liquid such as the drink or tea flows into gaps between a plurality of key caps and further flows into the conventional keyboard. When the liquid flows to a line of the membrane switch circuit or a circuit board within the conventional keyboard, a short circuit may occur to the line, so as to damage the membrane switch circuit or the circuit board, and cause the conventional keyboard fails to operate. In addition to the external liquid, dust is easier to enter the conventional keyboard through the gaps between the plurality of key caps.

Therefore, a protecting cover which may cover the keyboard is launched in the market. The protecting cover covers a plurality of key caps to make the gaps between the plurality of key caps not be exposed, and may provide a water-proof and dust-proof function. However, a conventional protecting cover affects pressing feel of the key cap.

### SUMMARY OF THE INVENTION

An objective of the present invention is providing a protecting cover which may have a water-proof and dust-proof function and good pressing feel.

Another objective of the present invention is providing a keyboard which may have a water-proof and dust-proof function and good pressing feel.

In a preferred embodiment, the present invention provides a protecting cover covered on at least one key cap of a keyboard. The protecting cover includes a connection pad and at least one cover body, where the connection pad is provided on a bottom plate of the keyboard. The cover body is provided on the connection pad and is covered at the key cap, and includes an upper cover portion and a side wall portion. The upper cover portion covers an upper surface of the key cap, and the side wall portion surrounds the upper cover portion and covers a side edge of the key cap, where thickness of the side wall portion is smaller than thickness of the key cap.

In a preferred embodiment, the present invention provides a keyboard, including a bottom plate, at least one key cap, and a protecting cover. The key cap is located above the bottom plate and may move with respect to the bottom plate. The protecting cover is covered on the key cap, and includes a connection pad and at least one cover body, where the connection pad is provided on the bottom plate. The cover body is provided on the connection pad and is covered at the key cap, and includes an upper cover portion and a side wall portion. The upper cover portion covers an upper surface of the key cap, and the side wall portion surrounds the upper cover portion and covers a side edge of the key cap, where thickness of the side wall portion is smaller than thickness of the key cap.

Briefly, it can be known from the above that the protecting cover of the present invention designs the side wall portion located at the side edge of the cover body to have a smaller thickness, so that the side wall portion may be merely slightly deformed, so as to reduce a degree for the side wall portion to be squeezed. Therefore, pressing feel of the key cap may be improved. In addition, a buffer portion may further be provided on the cover body, so as to relieve a situation that the side wall portion is squeezed, thereby further improving pressing feel of the keyboard.

### BRIEF DESCRIPTION OF THE DRAWINGS

FIG. 1 is a sectional schematic side view of a key structure of a conventional keyboard;

FIG. 2 is an exploded schematic structural diagram of a protecting cover and a keyboard of the present invention in a first preferred embodiment;

FIG. 3 is a schematic partial structural diagram of a protecting cover of the present invention in a first preferred embodiment;

FIG. 4 is a schematic partial structural diagram of a protecting cover of the present invention in a first preferred embodiment from another angle of view;

FIG. 5 is a sectional schematic side view of a local structure of a protecting cover and a keyboard of the present invention in a first preferred embodiment;

FIG. 6 is a schematic partial structural diagram of a keyboard of the present invention in a second preferred embodiment;

FIG. 7 is a schematic partial structural diagram of a keyboard of the present invention in a second preferred embodiment from another angle of view; and

FIG. 8 is a sectional schematic side view of a local structure of a keyboard of the present invention in a second preferred embodiment.

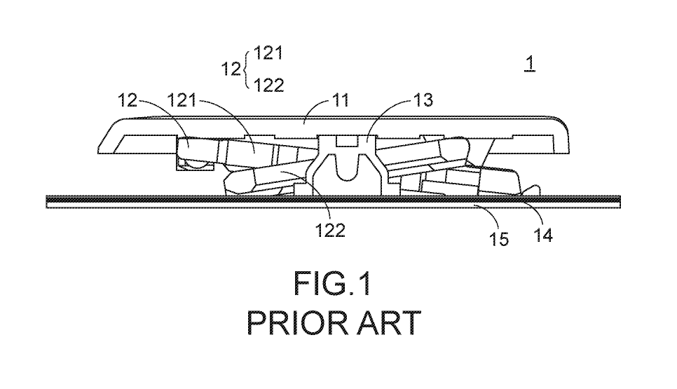

### DETAILED DESCRIPTION OF THE PREFERRED EMBODIMENT

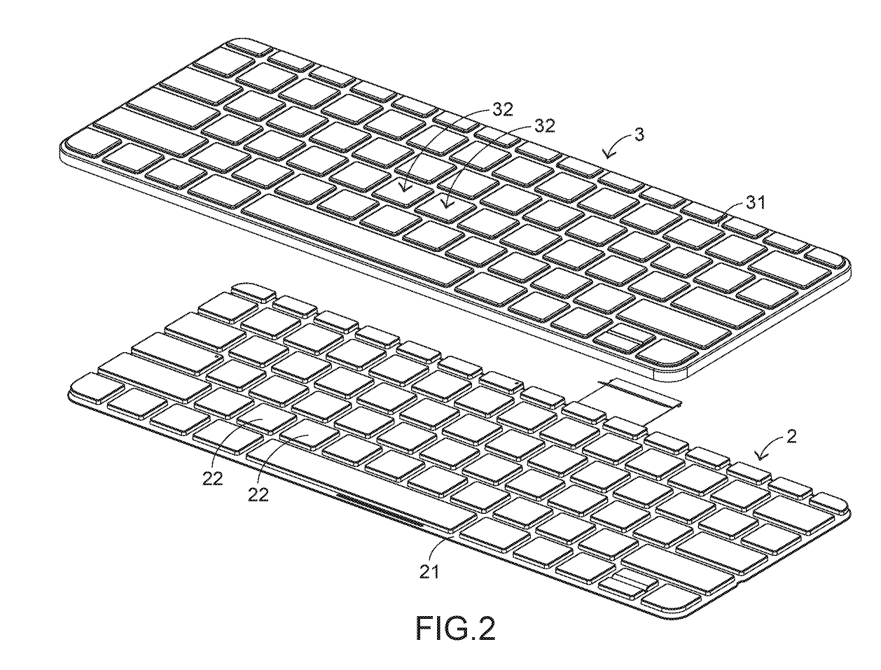

Regarding conventional technical problems, the present invention provides a protecting cover which may cover a keyboard to resolve the technical problems. Please refer to FIG. 2, and FIG. 2 is an exploded schematic structural diagram of a protecting cover and a keyboard of the present invention in a first preferred embodiment. FIG. 2 shows a keyboard 2 and a protecting cover 3. The keyboard 2 includes a bottom plate 21 and a plurality of key caps 22. However, other components of the keyboard 2 are as stated in the prior art, and therefore details are not described herein again. In order to maintain the figure clear to see, these components are not shown in the figure. The protecting cover 3 is covered on the plurality of key caps 22, and includes a connection pad 31 and a plurality of cover bodies 32, where the connection pad 31 is provided on the bottom plate 21 of the keyboard 2. The plurality of cover bodies 32 are in one-to-one correspondence to the plurality of key caps, are provided on the connection pad 31, and are covered at the corresponding key caps 22, respectively. In this preferred embodiment, the plurality of cover bodies 32 are integrally formed with the connection pad 31, and are made of a silicon material.

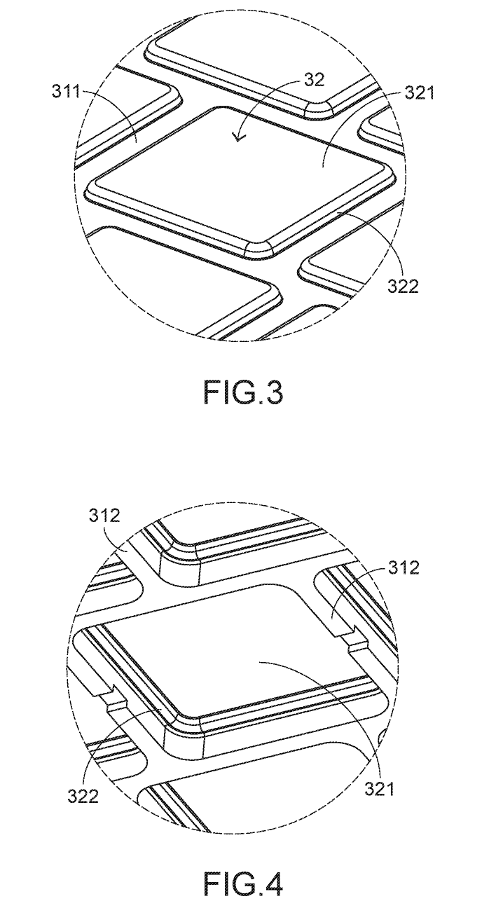

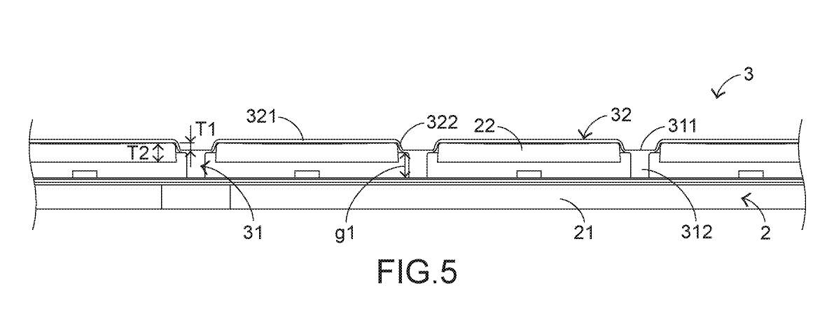

Subsequently, a detailed structure of the protecting cover 3 is described. Please refer to FIG. 3, FIG. 4, and FIG. 5 at the same time. FIG. 3 is a schematic partial structural diagram of a protecting cover of the present invention in a first preferred embodiment; FIG. 4 is a schematic partial structural diagram of a protecting cover of the present invention in a first preferred embodiment from another angle of view; and FIG. 5 is a sectional schematic side view of a local structure of a protecting cover and a keyboard of the present invention in a first preferred embodiment. In the protecting cover 3, the cover body 32 includes an upper cover portion 321 and a side wall portion 322. The upper cover portion 321 covers upper surfaces of the key cap 22, and the side wall portion 322 surrounds the upper cover portion 321 and covers various side edges of the key cap 22. That is, the side wall portion 322 covers the side edges surrounding the key cap 22. Thickness T1 of the side wall portion 322 is smaller than thickness T2 of the key cap 22, as shown in FIG. 5. In a preferred practice, thicknesses of the upper cover portion 321 and the side wall portion 322 are smaller than or equal to 0.3 mm.

In another aspect, the connection pad 31 includes a plurality of extension sheets 311 and a plurality of separation columns 312, where the extension sheets 311 are provided above the bottom plate 21, so that a gap g1 is provided between the extension sheets 311 and the bottom plate 21. Moreover, the extension sheets 311 are located between at least two cover bodies 32, and a function of the extension sheets 311 is connecting the cover bodies 32. In other words, the protecting cover 3 may form a sheet-like structure by using the plurality of extension sheets 311, as shown in FIG. 2. The separation columns 312 are in one-to-one correspondence to the plurality of key caps 22, are formed by extending downwards from the extension sheets 311, and are in contact with the bottom plate 21. The separation columns 312 surround the cover bodies 32, and may separate these key caps 22. The separation columns 312 may replace some frames in the keyboard, so that the keyboard may need not to provide additional frames therein.

FIG. 5 shows a structure that the protecting cover 3 covers the keyboard 2. When a user presses the upper cover portion 321 and the key cap 22, the key cap 22 may move downwards with respect to the bottom plate 21. Meanwhile, the upper cover portion 321 is forced to deform the side wall portion 322. The thickness T1 of the side wall portion 322 is much small, and the side wall portion 322 may be merely slightly deformed. Therefore, the deformed side wall portion 322 may be merely slightly squeezed. That is, deformation of the cover body 32 merely slightly affects pressing feel of the keyboard 2, and the user even cannot feel a change in the pressing feel.

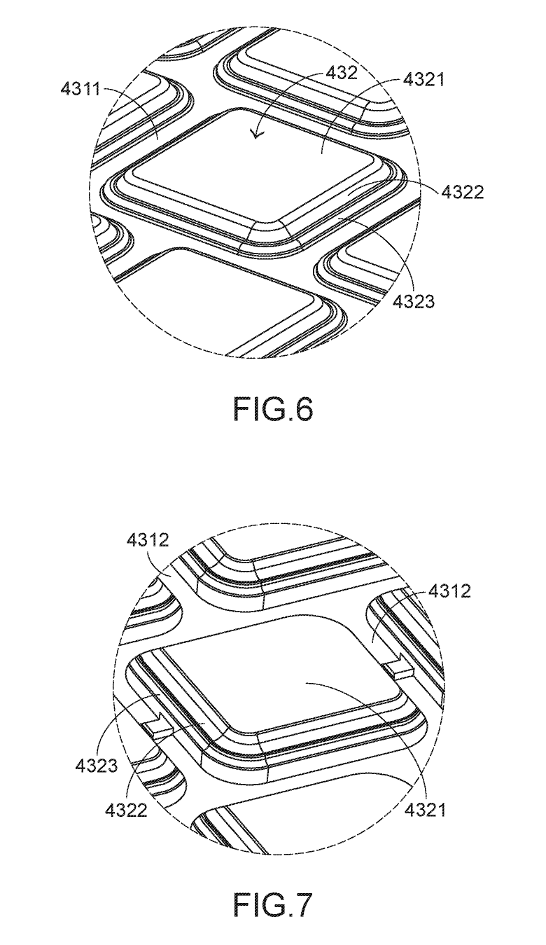

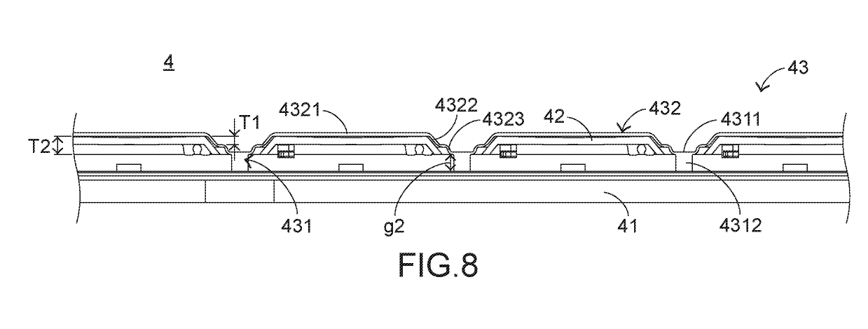

In addition, the present invention further provides a second preferred embodiment of a practice different from the above. Please refer to FIG. 6, FIG. 7, and FIG. 8 at the same time. FIG. 6 is a schematic partial structural diagram of a keyboard of the present invention in a second preferred embodiment; FIG. 7 is a schematic partial structural diagram of a keyboard of the present invention in a second preferred embodiment from another angle of view; and FIG. 8 is a sectional schematic side view of a local structure of a keyboard of the present invention in a second preferred embodiment. A keyboard 4 includes a bottom plate 41, a plurality of key caps 42, and a protecting cover 43. However, other components of the keyboard 4 are not shown in the figures. The protecting cover 43 is covered on the plurality of key caps 42, and includes a connection pad 431 and a plurality of cover bodies 432. Moreover, the connection pad 431 includes a plurality of extension sheets 4311 and a plurality of separation columns 4312. Structures and functions of various components of the protecting cover 43 are substantially same to those of the protecting cover 3 in the foregoing preferred embodiments, and details of the similarities are not described herein again. The protecting cover 43 in this preferred embodiment has two differences from the foregoing preferred embodiments. First, the protecting cover 43 is fixed on the bottom plate 41 and the plurality of key caps 42, while in this preferred embodiment, the protecting cover 43 is fixed on the bottom plate 41 and the plurality of key caps 42 in an adhesion manner. In other words, the protecting cover 43 is a part of the keyboard 4. Second, structures of the cover bodies 432 are different.

Regarding the cover bodies 432, each cover body 432 includes an upper cover portion 4321, a side wall portion 4322, and a buffer portion 4323. The upper cover portion 4321 covers upper surfaces of the key cap 42, and the side wall portion 4322 surrounds the upper cover portion 4321 and covers various side edges of the key cap 42. That is, the side wall portion 4322 covers the side edges surrounding the key cap 42. Thickness T1 of the side wall portion 4322 is smaller than thickness T2 of the key cap 42, as shown in FIG. 8. It should be noted that shape of the cover body 432 may be correspondingly changed with shape of the key cap 42. In this preferred embodiment, the side edges of the key cap 42 are slopes, and the side wall portion 4322 of the cover body 432 is designed as a corresponding slope shape, so that the protecting cover 43 may be bonded to the key cap 42 as possible. This is merely for illustration purposes, but does not form a limitation. In other words, corresponding structural changes may be made to the shape of the cover body in cooperation with the shapes of the side edges of the key cap.

The buffer portion 4323 is located between the side wall portion 4322 and the connection pad 431. When the cover body 432 and the corresponding key cap 42 are pressed, the buffer portion 4323 may be driven by the side wall portion 4322 to bend, thereby avoiding the side wall portion 4322 being squeezed. By using a structure of the buffer portion 4323, a situation that the side wall portion 4322 is squeezed may be further relieved, thereby improving pressing feel of the keyboard 4. In a preferred practice, thicknesses of the upper cover portion 4321, the side wall portion 4322, and the buffer portion 4323 are smaller than or equal to 0.3 mm. It can be known from FIG. 8 that there is a gap g2 between the buffer portion 4323 and the bottom plate 41. The gap g2 may provide a space for the side wall portion 4322 and the buffer portion 4323 to be deformed, so as to relieve a situation that feel of the gap bodies 43 is affected because the bodies 43 are squeezed.

It can be known from the above that the protecting cover of the present invention designs the side wall portion located at the side edge of the cover body to have a smaller thickness, so that the side wall portion may be merely slightly deformed, so as to reduce a degree for the side wall portion to be squeezed. Therefore, pressing feel of the key cap may be improved. In addition, a buffer portion may further be provided on the cover body, so as to relieve a situation that the side wall portion is squeezed, thereby further improving the pressing feel of the keyboard. Therefore, the protecting cover and the keyboard of the present invention may absolutely resolve the convention technical problems.

The foregoing is merely the preferable embodiments of the present invention, and is not intended to limit the scope of the present invention. Therefore, any other equivalent replacement or modification made without departing from the spirit disclosed by the present invention shall fall within the scope of the present invention.

What is claimed is:

1. A protecting cover, covered on at least one key cap of a keyboard, wherein the protecting cover comprises:
a connection pad, provided on a bottom plate of the keyboard; and
at least one cover body, provided on the connection pad and covered at the key cap, wherein the cover body comprises:
an upper cover portion, covering an upper surface of the key cap; and
a side wall portion, surrounding the upper cover portion and covering a side edge of the key cap, wherein thickness of the side wall portion is smaller than thickness of the key cap.

2. The protecting cover according to claim 1, wherein the connection pad comprises:
at least one extension sheet, provided above the bottom plate, and located between two cover bodies, so as to connect the two cover bodies; and
at least one separation column, formed by extending downwards from the extension sheet, and in contact with the bottom plate, wherein the separation column surrounds the cover body, so as to separate these key caps.

3. The protecting cover according to claim 1, wherein thicknesses of the upper cover portion and the side wall portion are smaller than or equal to 0.3 mm.

4. The protecting cover according to claim 1, wherein the cover body further comprises a buffer portion which is located between the side wall portion and the connection pad, so as to be driven to bend when the cover body and the key cap are pressed, thereby avoiding the side wall portion of the cover body being squeezed.

5. The protecting cover according to claim 4, wherein thicknesses of the upper cover portion, the side wall portion, and the buffer portion are smaller than or equal to 0.3 mm.

6. A keyboard, comprising:
a bottom plate;
at least one key cap, located above the bottom plate and may move with respect to the bottom plate; and
a protecting cover, covered on the key cap, wherein the protecting cover comprises:
a connection pad, provided on the bottom plate; and
at least one cover body, provided on the connection pad, wherein the cover body comprises:
an upper cover portion, covering an upper surface of the key cap; and
a side wall portion, surrounding the upper cover portion and covering a side edge of the key cap, wherein thickness of the side wall portion is smaller than thickness of the key cap.

7. The keyboard according to claim 6, wherein the connection pad comprises:
at least one extension sheet, provided above the bottom plate, and located between two cover bodies, so as to connect the two cover bodies; and
at least one separation column, formed by extending downwards from the extension sheet, and in contact with the bottom plate, wherein the separation column surrounds the cover body, so as to separate these key caps.

8. The keyboard according to claim 6, wherein thicknesses of the upper cover portion and the side wall portion are smaller than or equal to 0.3 mm.

9. The keyboard according to claim 6, wherein the cover body further comprises a buffer portion which is located between the side wall portion and the connection pad, so as to be driven to bend when the cover body and the key cap are pressed, thereby avoiding the side wall portion of the cover body being squeezed.

10. The keyboard according to claim 9, wherein thicknesses of the upper cover portion, the side wall portion, and the buffer portion are smaller than or equal to 0.3 mm.
